(19) United States
(12) Patent Application Publication
(10) Pub. No.: US 2022/0191108 A1
(43) Pub. Date: Jun. 16, 2022

(54) COMBINED SECURITY AND SERVER MANAGEMENT SYSTEM AND RELATED APPLICATION

(71) Applicant: BCD International, Inc., Buffalo Grove, IL (US)

(72) Inventor: Alberto Feliciano, Buffalo Grove, IL (US)

(21) Appl. No.: 17/119,595

(22) Filed: Dec. 11, 2020

(51) Int. Cl. H04L 12/24; G06Q 10/06; G06F 9/445; H04L 12/26; G06F 3/0484

(52) U.S. Cl. CPC H04L 41/22; G06Q 10/0631; G06Q 10/0639; G06F 21/62; H04L 43/14; G06F 3/0484; G06F 9/44526

(57) ABSTRACT

A system which combined security and server management. Disclosed is an application, in the form of an iDRAC plugin, that integrates a server management system with a security system. The application provides a user interface that allows one to simultaneously monitor and manage both systems. The application provides a solution which companies, organizations, etc. can use to manage multiple types of systems effectively from a single point. The solution reduces the knowledge requirement to gain further control of critical and IT infrastructure. As a result, operators at the lowest level can manage and act upon events without the elevated knowledge required of more complex systems.

### BACKGROUND

The present invention generally relates to security systems and server management systems, and more specifically relates to a novel and inventive system which effectively combines security and server management.

Currently, companies and organizations use one set of products and services to manage critical infrastructure, such as computer hardware (i.e., servers, etc.), and a totally different set of products and services to manage security systems (i.e., access control, etc.). Having to use several different products to manage the different areas of responsibility not only requires a high committal of resources, such as personnel, training, and funds, but also results in a complex web of responsibility that is difficult to manage and operate.

Personnel that is trained to monitor and operate a security system do not also monitor and operate server management systems. In other words, security guards are not responsible for dealing with or monitoring a server management system, and vice versa. After all, given the complexity of the server management system (and the alerts associated therewith), people responsible for the security system lack the requisite training.

### SUMMARY

One object of an embodiment of the present invention is to provide a combined security and server management system.

Another object of an embodiment of the present invention is to provide an application that integrates a server management system with a security system.

Another object of an embodiment of the present invention is to provide a user interface that allows one to simultaneously monitor and manage both a server management system and a security system, thereby effectively combining the two systems.

Still another object of an embodiment of the present invention is to provide a security system that monitors servers.

Briefly, an embodiment of the present invention provides a solution for companies, organizations, etc. to use to manage multiple types of systems effectively from a single point. The solution is a combined security and server monitoring system that reduces the knowledge requirement to gain further control of critical and IT infrastructure. As a result, operators at the lowest level can manage and act upon events without the elevated knowledge required of more complex systems.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 provides a block diagram of a system which is in accordance with an embodiment of the present invention, wherein security and server management is combined;

FIG. 2 shows the architecture of the overall system, wherein the system comprises an iDRAC plugin which is in accordance with an embodiment of the present invention, wherein the iDRAC plugin integrates multiple systems and provides a single user interface; and

FIGS. 3-11 are self-explanatory flow charts that relate to the function and operation of the system.

### DESCRIPTION

While this invention may be susceptible to embodiment in different forms, there is shown in the drawings and will be described herein in detail, a specific embodiment with the understanding that the present disclosure is to be considered an exemplification of the principles of the invention and is not intended to limit the invention to that as illustrated.

To date, there has not been any motivation in the industry to combine a security system with a server management system. Both systems are complex and, as a result, in the industry, security guards are security guards and server management people are server management people. The two systems are kept separate and each system is complex and requires a distinct level of expertise to monitor and interact with each system.

An embodiment of the present invention provides a combined system that effectively combines a security system with a server management system, and provides a user interface that is simplified such that a person can easily monitor and operate the combined system.

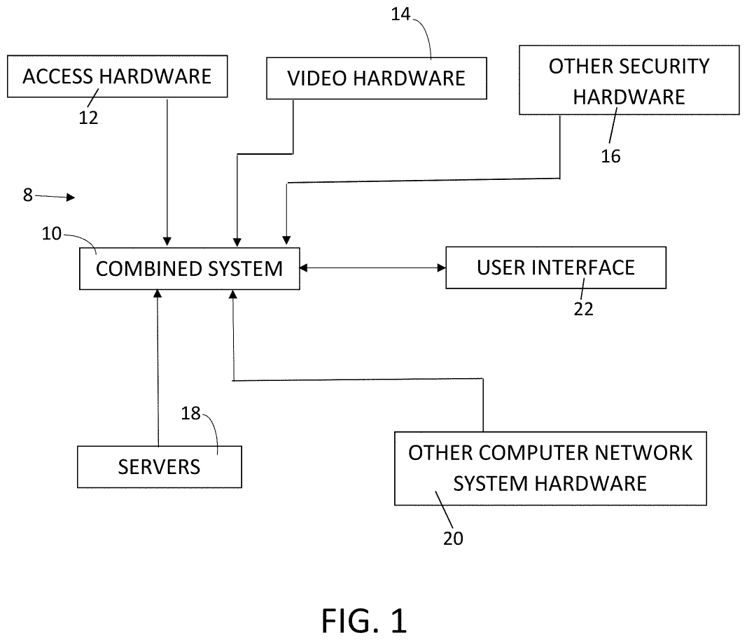

FIG. 1 provides a block diagram of an overall system 8 which is in accordance with an embodiment of the present invention, wherein security and server management is combined. As shown, a combined system 10 is configured to receive information from access hardware 12 (such as identification scanners), video hardware 14 and other security hardware 16 (such as door sensors, license plate scanners, etc.) typically associated with a security system, as well as receive information from one or more servers 18 and other computer system network hardware 20 typically associated with a server management system. The combined system 10 provides a user interface 22 that displays information related to all connected hardware in a way that is easy to understand, specifically to personnel not specifically and comprehensively trained in IT. As such, the overall system 8 provides a combined security and server management system, presented in a ‘single plane of glass’ via an intuitive user interface 22.

An embodiment of the present invention provides an application that implements the combination, preferably in the form of a plugin that effectively integrates a server management system with a security system, and provides a user interface that allows one to simultaneously monitor and manage the combined system.

Specifically, the server management system is preferably an iDRAC (integrated Dell Remote Access Controller), and preferably an embodiment of the present invention comprises an application in the form of an iDRAC plugin. The application or plugin is configured to integrate with a security center platform, such as a security center platform that is configured to provide access control, video surveillance, intrusion protection, analytics, communications, as well as possibly also automatic license plate reading. Specifically, the application or plugin may be specifically configured to integrate with a security system, such as the Genetec Security Center platform, which provides all the previously identified functionality (i.e., access control, video surveillance, intrusion protection, analytics, communications, as well as possibly also automatic license plate reading).

Preferably, the plugin is built on the Genetec SDK (Software Development Kit) platform and is configured to leverage many advantages that are found within the Genetec Security Center platform, such as the creation of entities, event-to-actions, and role fail-over. Preferably, the application is configured to enhance the user experience by introducing virtual machine management while staying true to the Genetec platform.

The Harmonize iDRAC plugin in accordance with an embodiment of the present invention is configured to provide the user with easier visibility to monitor, maintain, and react to their critical server infrastructure. As server uptime is vital to success in all vertical markets, the iDRAC plug-in provides operators the agility to make rapid response decisions with real-time notifications and data.

Among the features and benefits unique to the integration provided by the iDRAC plugin are real-time server telemetry, remote server management, server analytics, seamless integration into the Genetec Security Center platform (or other security center platform), and a reduction in the number of systems users need to manage.

The iDRAC plugin is configured to provide a solution for organizations to operate within a ‘single pane of glass’ (i.e., meaning that it provides the ability to manage other systems and products from a single point). The system provides both server management information and security center information in a single screen for both monitoring purposes and for taking action. The iDRAC plugin reduces the knowledge requirement for security personnel to monitor the organization's critical and IT infrastructure. Operators at the lowest level can manage and act upon events without the elevated knowledge required of more complex systems and streamlines communication.

As mentioned above, preferably the plugin is built on the Genetec SDK (Software Development Kit) platform and is configured to leverage many advantages that are found within the Genetec Security Center platform. More specifically, preferably, the iDRAC plugin utilizes two vast SDK components: the Genetec Security Center SDK and the Dell iDRAC API. Both platforms require a high degree of learning in order to operate effectively and there is an even more vast learning curve to implement their respective programming utilities. The iDRAC plugin effectively partners with both Genetec and Dell to leverage both technologies in a single solution.

The iDRAC plugin does not change the core functionality of either Genetec or iDRAC, but does provide enhancements. The iDRAC plugin effectively alters the user experience in an IT security setting, and reduces the inundation of data to which end users are exposed on a day to day basis. Operators who, before had to manage multiple systems, gain the capability to monitor and act on both security events and infrastructure events from the same application. Data is passed seamlessly from one application to the other, resulting in a lessening of a burden on IT teams and the overall bottom line.

The iDRAC plugin effectively provides unified integration between Genetec Security Center and the Dell iDRAC interface, and preferably utilizes the Genetec Security Center 5.9.0 SDK and Dell iDRAC 9 with Lifecycle Controller 3.36.36.36-4.10.10.10.

Telemetry and analytics are valuable tools that all organizations struggle to wield to maximum efficiency. The iDRAC plugin targets critical infrastructure by integrating the Dell iDRAC framework with Genetec Security Center. Preferably, the iDRAC plugin is a full Genetec plugin that integrates with the core Security Center platform.

Preferably, the iDRAC plugin utilizes the Redfish API to integrate iDRAC into SC. The plugin is configured to fetch hardware data, system data, and perform analytics that is presented to users in the Security Desk. Additionally, administrators can define custom entities within Config tool as well as health thresholds deemed necessary.

The iDRAC plugin utilizes Genetec Custom Events as communication between client and server applications as well as hooks for operators to utilize within SC or through other management options such as Genetec Mission Control.

All organizations have the need to monitor, maintain, and react to their critical server infrastructure. Server up time is vital to success in all verticals. The iDRAC plugin provides operators the agility to make rapid response decisions with real-time notifications and data. The iDRAC plugin preferably provides, among others, the following features and benefits: Real-time server telemetry, remote management, server analytics, seamless integration into the Genetec Security Center platform, and a reduction in the number of systems users need to manage.

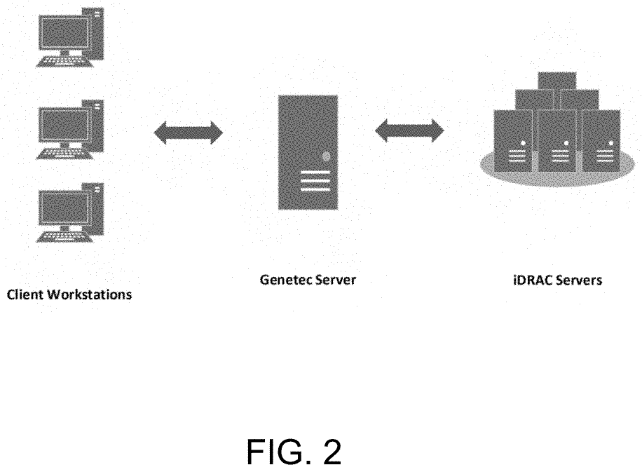

FIG. 2 shows the architecture of the overall system. As shown, an embodiment of the present invention provides an iDRAC plugin (i.e., in one of more of the iDRAC servers on the right in the Figure) which is configured to effectively integrate a server management system (i.e., the iDRAC servers) with one or more security systems (such as the Genetec Server shown in the middle of the Figure, which preferably runs the Genetec Security Center), and provides a unified user interface (i.e., a graphic user interface (GUI)) at one or more of the Client Workstations), through which a user can use to monitor and manage both systems. For example, alerts relating to both systems come through the user interface, and both systems can be controlled through the user interface. The server in the middle of the Figure is preferably configured to provide security functions, such as access control, video surveillance, intrusion protection, analytics, communications, as well as possibly also automatic license plate reading. As such, from a single client workstation, through a single user interface, a user can monitor and manage both the security system (i.e., run on the Genetec server) and the iDRAC servers.

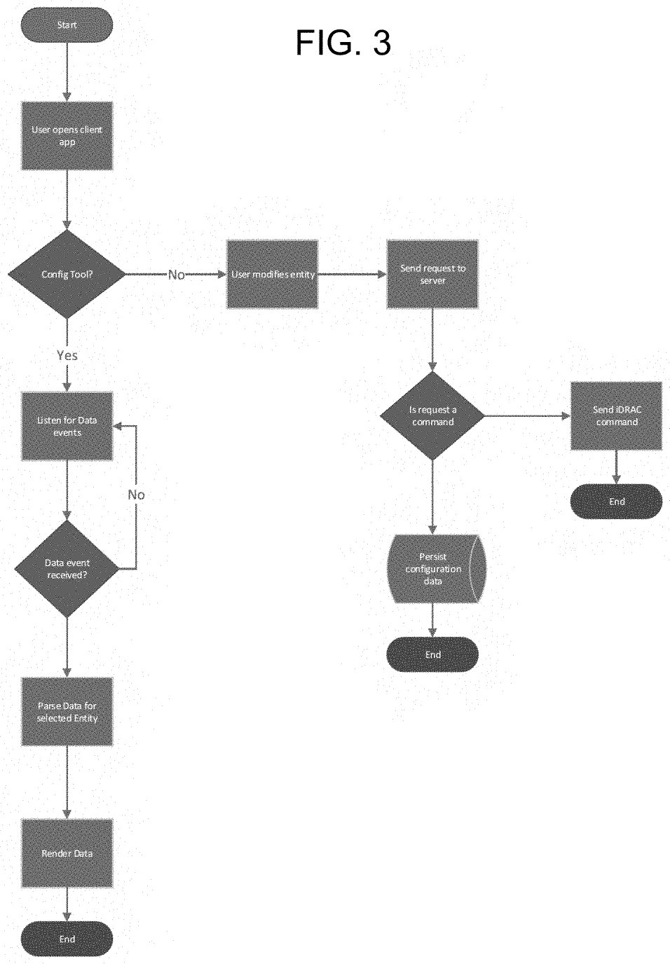

FIGS. 3-11 are flow charts that are self-explanatory.

Genetec Security Center is comprised of two applications—Config Tool and Security Desk. FIG. 3 shows that when a user opens the Genetec client, the iDRAC plugin checks to see if the Client is the Config Tool. If it is not, the iDRAC plugin effectively listens for data events from the Genetec Server. When received, it renders the data into the GUI. If the client is Config Tool, when the users selects a server entity, the iDRAC plugin gets the iDRAC server data from the Genetec server. The user is able to send iDRAC commands or modify the iDRAC server configuration.

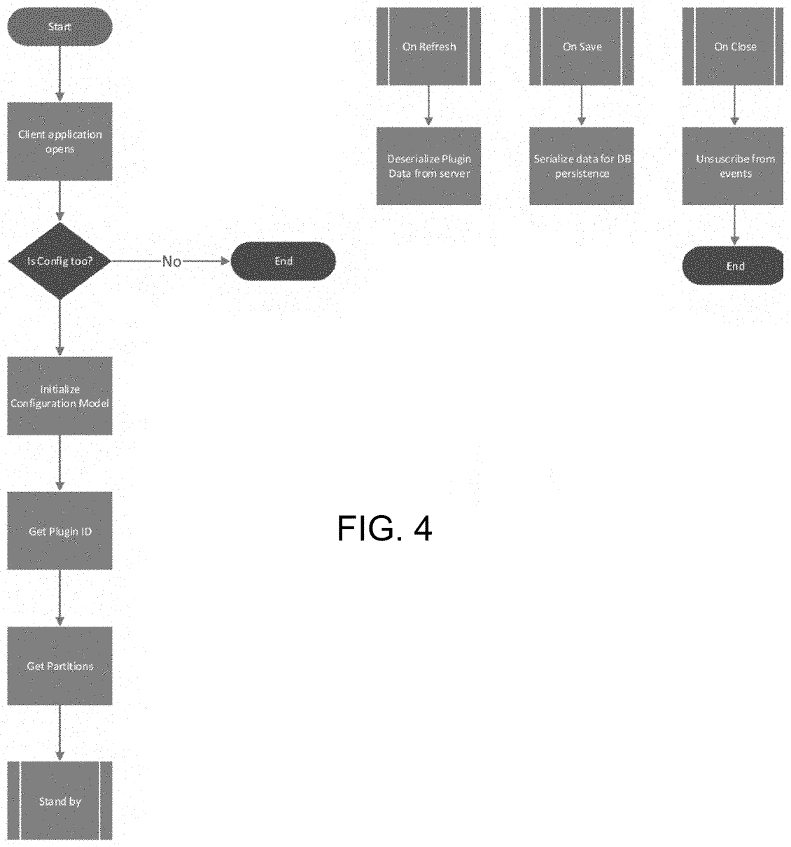

FIG. 4 shows that when a user opens the Genetec Client, the iDRAC plugin checks to see if the client is Config tool. If it is, the iDRAC plugin initializes the plugin data model and retrieves the Plugin ID from the Genetec server. It also retrieves any partitions and the awaits user input. When the data model refreshes, data is repopulated from the Genetec server. When the user saves data, the data is serialized as XML into the Genetec database. When the application closes, any event subscriptions are disposed.

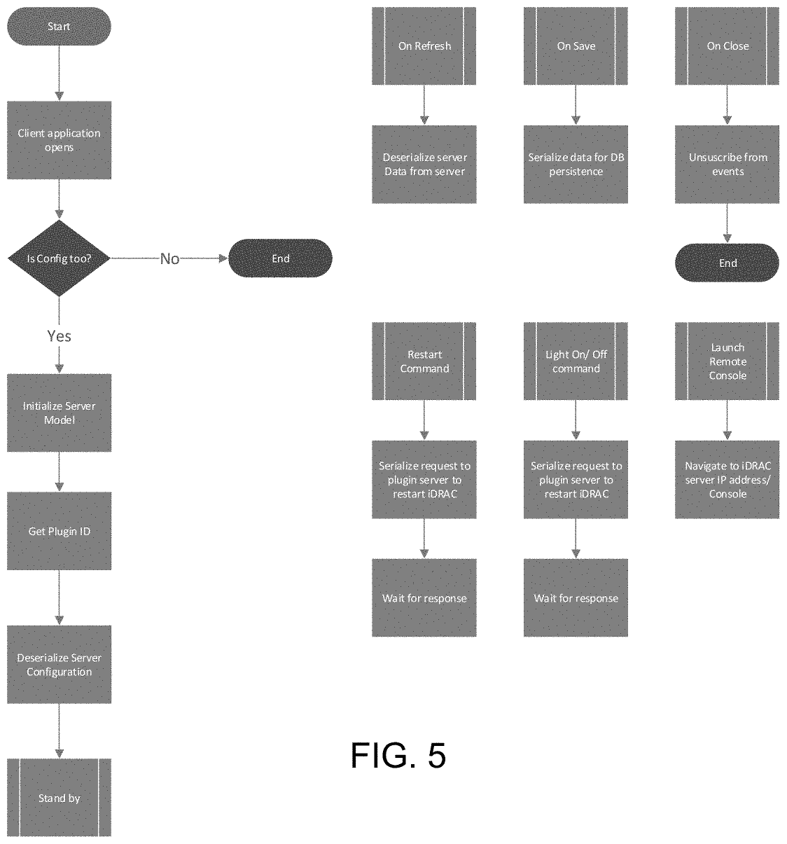

FIG. 5 shows that when a user opens the Genetec Client, the iDRAC plugin checks to see if the client is Config tool. If it is, the iDRAC plugin initializes the iDRAC server data model and retrieves the Plugin ID from the Genetec server. It also deserializes an object model from the Genetec server. When the data model refreshes, data is repopulated from the Genetec server. When the user saves data, the data is serialized as XML into the Genetec database. When the application closes, any event subscriptions are disposed. When the user issues the restart command, the request is serialized and sent to the Genetec Server. When the user issues the LightSwitch command, the request is serialized and sent to the Genetec Server. When the user requests access into the remote console, the browser control navigates to the configured IP address.

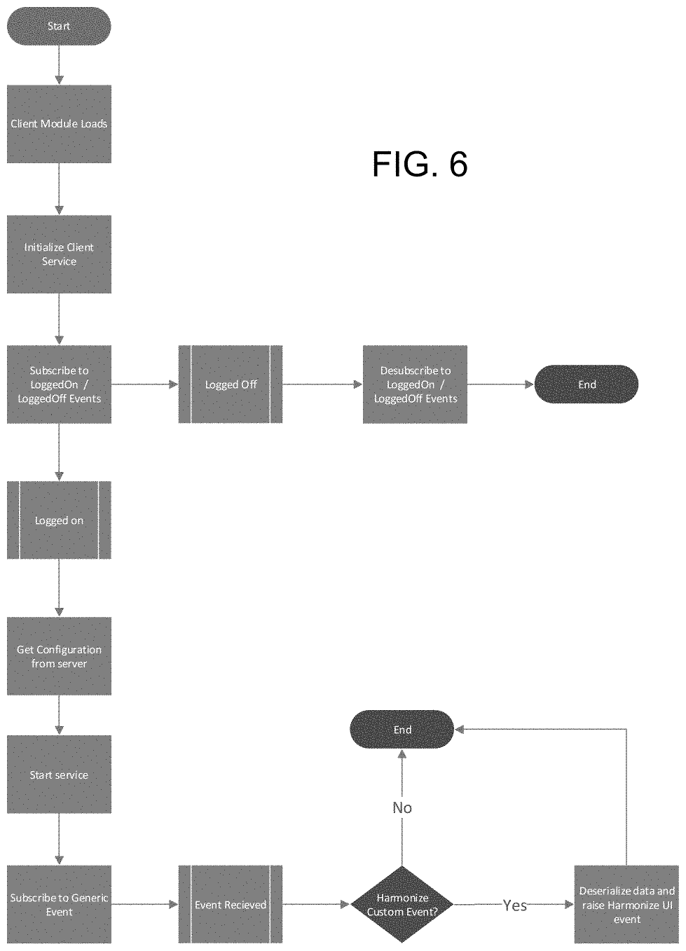

FIG. 6 shows that when the client application starts, the iDRAC plugin client service initializes by subscribing to the Logged in and Logged off events. When the Logged On event is received, the service gets the plugin configuration from the server and starts the service. The service listens for any the iDRAC plugin data events and passes them to the iDRAC plugin Security Desk user interface. When Logged Off, all event subscriptions are disposed.

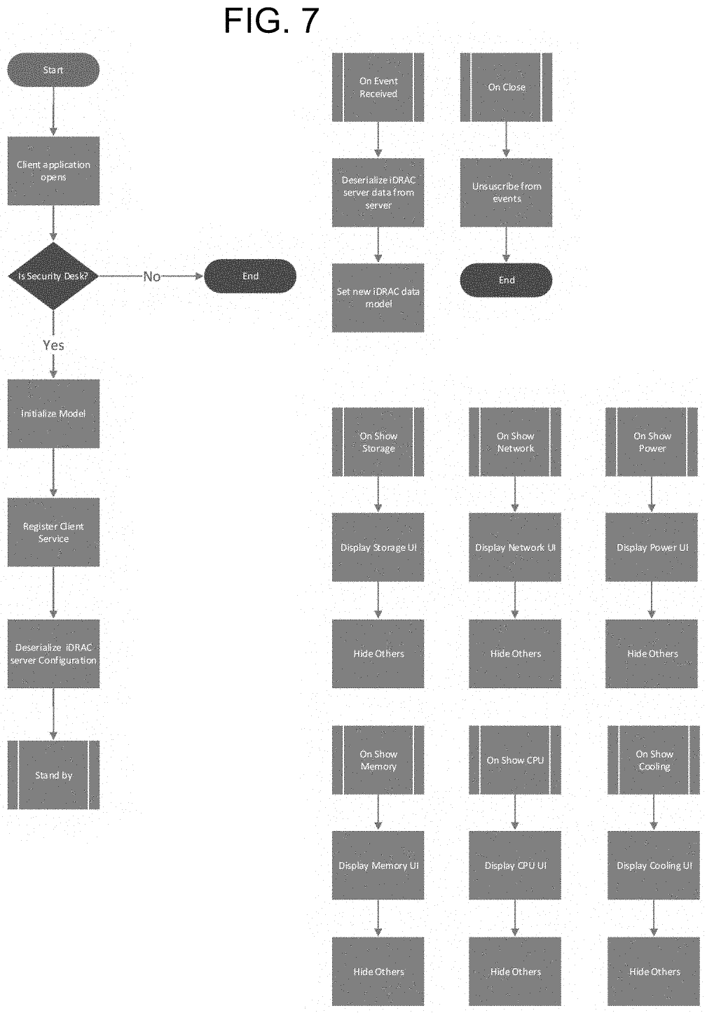

FIG. 7 shows that when a user opens the Genetec Client, the iDRAC plugin checks to see if the client application is Security Desk. If it is, the iDRAC plugin initializes the iDRAC server data model and retrieves the Plugin ID from the Genetec server. It also registers the client service to receive data events and deserializes the iDRAC server configuration from the Genetec server. When an event is received, a new data model is deserialized to refresh the user interface. The user can hide and show data relating to, for example: storage, the network, power, memory, the CPU, and cooling.

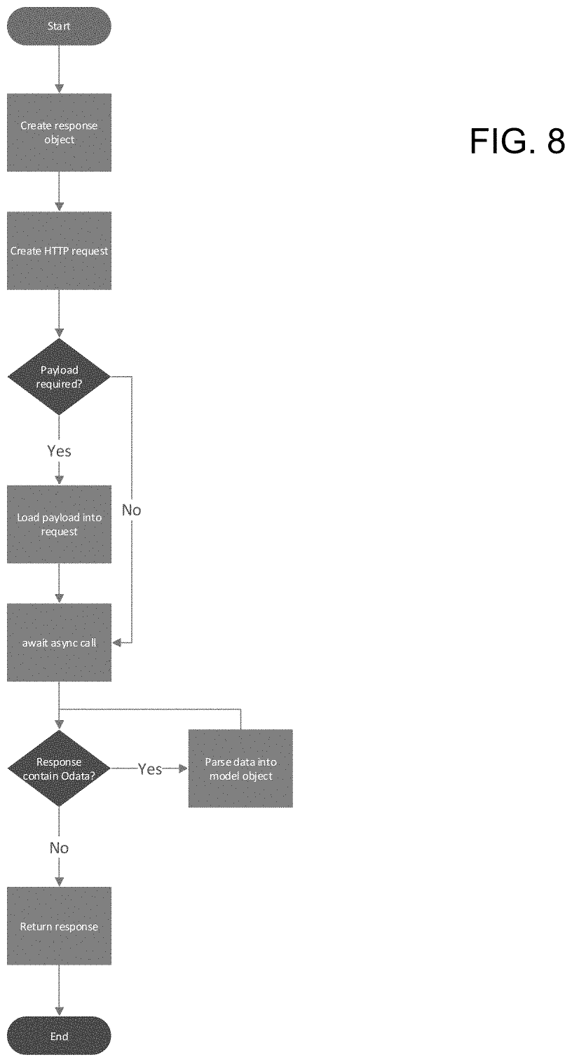

FIG. 8 is a representation of all the iDRAC API calls made by the iDRAC plugin. Preferably, an async HTTP request is made with any required payloads. If the response contains data in OData format, the response object is parsed until it is consumable by the iDRAC plugin.

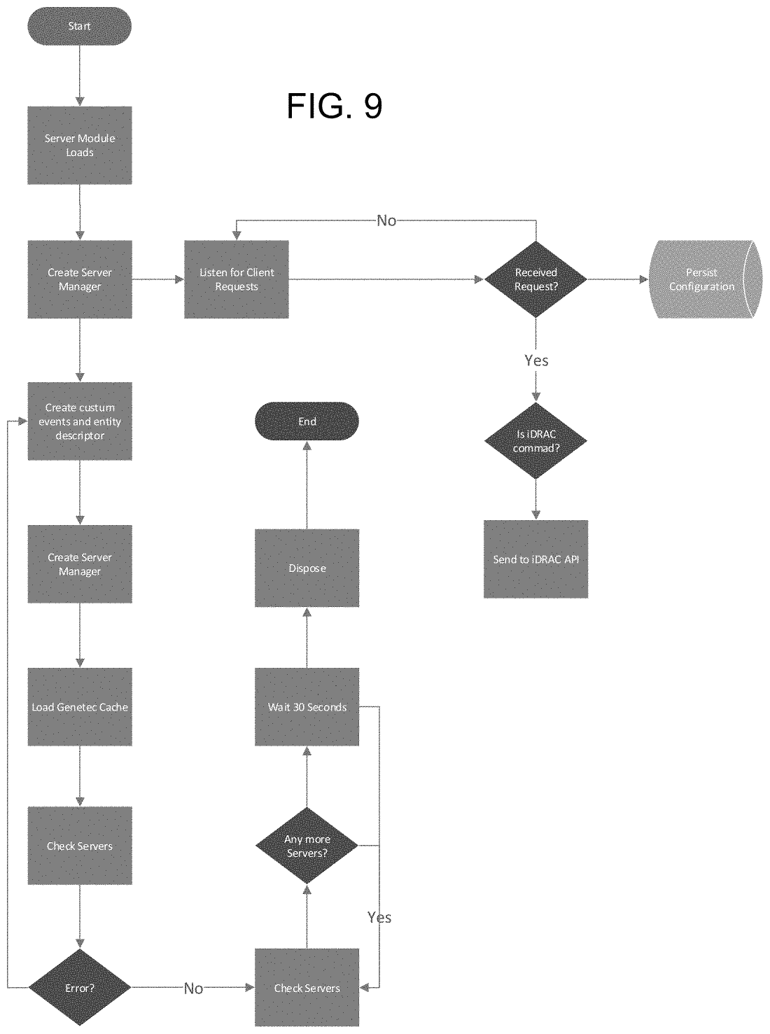

FIG. 9 shows that the iDRAC plugin server component initializes with the Genetec service. When loaded, an iDRAC server manager is created. This is the main server process in the iDRAC plugin. Preferably, the server manager caches all created iDRAC servers in Genetec and polls each one every 30 seconds for health data and telemetry. The manager is also responsible for handling any commands or requests initiated by users from the Security Desk client.

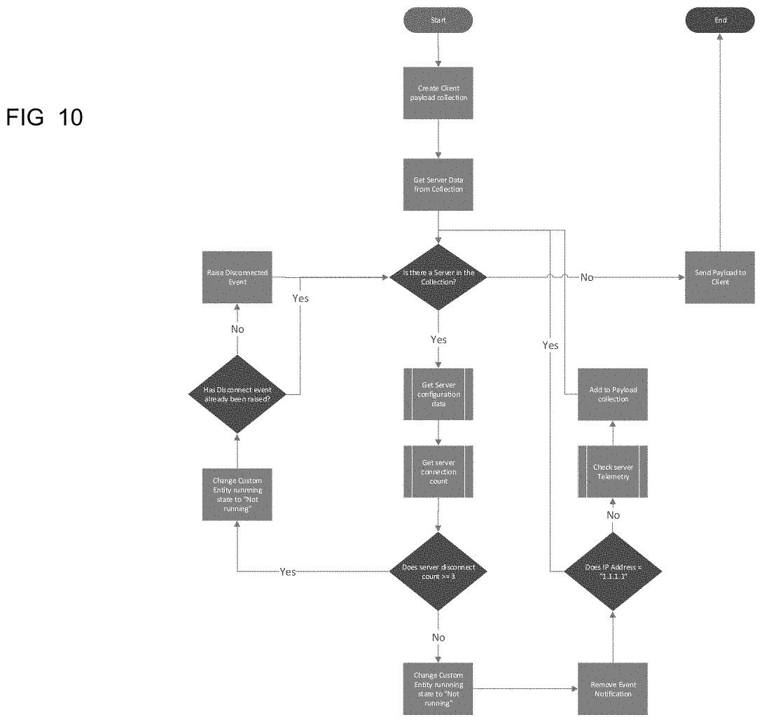

FIG. 10 shows that when the Server manager initializes, all iDRAC servers are cached in a collection. The manager iterates through the servers and sends a data event to all subscribed clients. Preferably, the manager attempts to connect with each server 3 times before marking the server as “offline”, and then an event is raised to be handled by the user. If connectivity exists with the server, telemetry data is retrieved and parsed and sent to all clients.

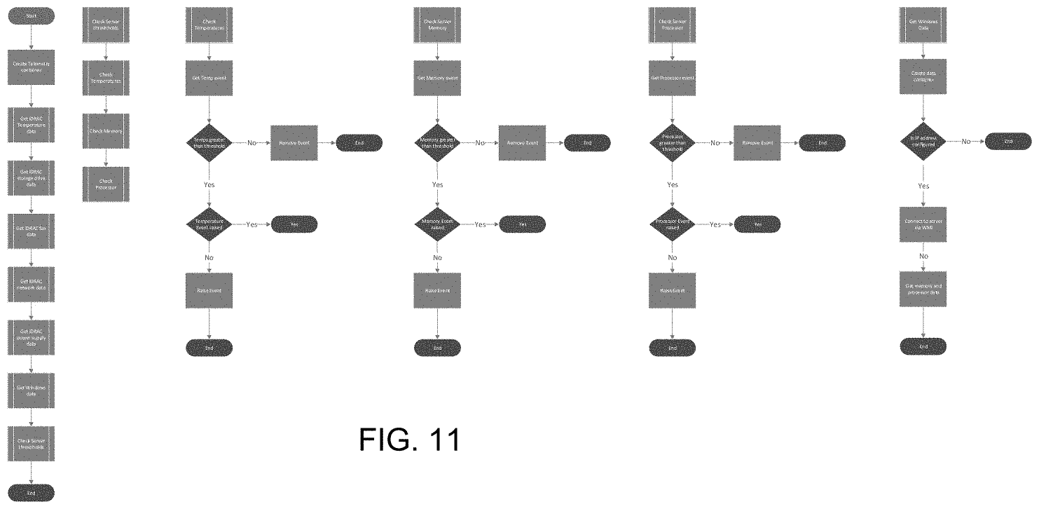

FIG. 11 shows that when checking server data, the iDRAC plugin makes async calls to iDRAC for data relating to the following: temperature, storage, the network, and power supply. Preferably, a separate async call is made to Windows WMI to get the processor and memory data. Preferably, the data is compared to the configured thresholds set by the user. If the threshold is exceeded, an event is raised for user processing.

With regard to the structure of the iDRAC that provides the functionality (i.e., the fact that it integrates the two systems and provides a single user interface for monitoring and management of the two systems), the Harmonize iDRAC is comprised of 3 distinct code binaries or “DLLS” (Dynamic Link-Libraries). Referred to as “Modules”, these DLLS segment Harmonize iDRAC into 2 Modules—the Harmonize iDRAC Client module and the Harmonize iDRAC Server Module. The 3rd DLL is referred to as “Common”, and is a code library that is referenced by both the client and server modules. The client module DLL is referenced by the Genetec client application and contains all of the client-side logic and graphical user interfaces. The server module is consumed by the Genetec Plugin Role and contains all of the business logic utilized by Harmonize iDRAC.

The iDRAC plugin described herein provides a very unique insight, or single pane of glass view, within the Video Management system. In the industry, security directors and key decision makers lack the technical ability to determine the best course of action, to mitigate server-related outages when they occur. More often than not, decision makers are forced to contact their Video Management system vendor, in an attempt to drive resolution to these critical outages. In most cases, the decision makers can provide little insight as to metrics, or resource depletion of the servers that comprise their physical security system. The lack of detailed information leads to extended outages of critical resources, and requires multiple entities to derive the required information. By effectively providing a single pane of glass (a user-friendly user interface that provides information on both systems) within the Video Management System, the iDRAC plugin described herein empowers the key decision makers to drive faster resolution, and contact the appropriate vendor, based on metrics. In turn, the critical outage is reduced, resulting in minimal loss.

The iDRAC plugin is unique in that it opens doors and makes the iDRAC accessible to non-technical people by providing a user-friendly user interface that is not overly complicated. Preferably, the iDRAC plugin is configured to expands the capabilities of Dell iDRAC notification, and allows there to be custom responses to alerts such as both visual and audio cues that are otherwise not accessible through native iDRAC.

Before the present invention, typical response initiated with the local IT administrator monitoring and receiving information from iDRAC. This is assuming that the administrator is on staff and available. When received, the IT admin must follow their processes and procedures to get that information to operations who then in turn begin another set of processes and procedures. The iDRAC disclosed herein simplifies this series of interactions.

In short, security Integrators can offer more value at less cost by implementing the iDRAC plugin disclosed herein.

The resulting combined system collates IT-related events, such as heat, disk RPM, predictable Drive failure, etc. These events previously were relayed through SMTP (Simple Mail Transfer Protocol). This integration allows for the use of the VMS platform as a delivery mechanism within the Security and integrator space. In the past, SMTP was usually used only with IT protocols. The combined system takes the events and alerts and displays them in a visual cue through an event inside of the receiving VMS/Security Platform.

The iDRAC plugin results in the iDRAC working seamlessly with the Genetec Security Center suite. This allows for entire network resolution from one familiar interface. As a result, the security staff no longer needs to learn how to access the server's complex management system via an out-of-band management interface. By simplifying its functionality, the security staff can easily monitor the core system parameters and streamline support calls by directly dialing in on the faulty part without spending hours on the phone with a support representative. The Security Center interface allows the security guard to receive live, onscreen alerts about the status and state of the network server. This eliminates the need for SNMP alerts or email relays which require IT professionals to setup and configure. As a result, the organization saves time and money.

In the above description, Dell, Harmonize and Genetec and all trademarks of their respective owners.

While a specific embodiment of the invention has been shown and described, it is envisioned that those skilled in the art may devise various modifications without departing from the spirit and scope of the present invention.

What is claimed is:

1. A system comprising: security system hardware; server management hardware; a combined system connected to the security system hardware and server management hardware and configured to provide a user interface that displays information relating to both the security system hardware and server management hardware.

2. The system as recited in claim 1, wherein the combined system comprises a plugin with regard to a server management system which comprises the server management hardware.

3. The system as recited in claim 1, wherein the security system hardware comprises access hardware.

4. The system as recited in claim 1, wherein the security system hardware comprises video hardware.

5. The system as recited in claim 1, wherein the server management hardware comprises at least one server.

6. The system as recited in claim 1, wherein the user interface is configured to allow a user to take action with regard to one or more items being monitored by the system.

7. The system as recited in claim 1, wherein the user interface is configured to allow a user to selectively hide and show data relating to at least one of storage, a network, power, memory, a CPU, and cooling.

8. The system as recited in claim 1, wherein the user interface is configured to allow a user to selectively hide and show data relating to both the security system hardware and server management hardware.

9. A plugin comprising software which causes a combined system to receive information from security system hardware and server management hardware and display information on a user interface relating to both the security system hardware and server management hardware.

10. The plugin as recited in claim 8, wherein the security system hardware comprises access hardware.

11. The plugin as recited in claim 8, wherein the security system hardware comprises video hardware.

12. The plugin as recited in claim 8, wherein the server management hardware comprises at least one server.

13. The plugin as recited in claim 8, wherein the plugin allows a user to take action with regard to one or more items being monitored by the system.

14. The plugin as recited in claim 8, wherein the plugin allows a user to selectively hide and show data relating to both the security system hardware and server management hardware.

15. The plugin as recited in claim 8, wherein the plugin allows a user to selectively hide and show data relating to at least one of storage, a network, power, memory, a CPU, and cooling.
